(19) United States
(12) Patent Application Publication
(10) Pub. No.: US 2021/0127059 A1
(43) Pub. Date: Apr. 29, 2021

(54) CAMERA HAVING VERTICALLY BIASED FIELD OF VIEW

(71) Applicant: Microsoft Technology Licensing, LLC, Redmond, WA (US)

(72) Inventors: Karlton David POWELL, Lake Stevens, WA (US); Russell Irvin SANCHEZ, Seattle, WA (US); Michael Chia-Yin LIN, Kirkland, WA (US); Rhishikesh Ashok SATHE, Bothell, WA (US)

(73) Assignee: Microsoft Technology Licensing, LLC, Redmond, WA (US)

(21) Appl. No.: 16/667,592

(22) Filed: Oct. 29, 2019

(51) Int. Cl. H04N 5/232; H04N 5/225; G06T 5/00; H04N 5/247; G02B 13/00

(52) U.S. Cl. CPC H04N 5/23238; H04N 5/2254; G06T 2207/20081; H04N 5/247; G02B 13/0005; G06T 5/006

(57) ABSTRACT

A camera is disclosed. The camera includes an image sensor and a f-theta lens fixed relative to the image sensor. The f-theta lens is configured to direct object light from a scene onto the image sensor. An optical axis of the f-theta lens is offset from an optical center of the image sensor such that the image sensor is configured to capture a field of view having an angular bias relative to the optical axis of the f-theta lens.

### BACKGROUND

A camera typically includes a lens and an image sensor rigidly attached to one another such that an optical axis of the lens is aligned with an optical center of the image sensor. Such alignment allows for the camera to be pointed at a subject of interest in order to image the subject of interest, while making optimal/efficient use of the image sensor area. For example, such a camera can be pointed by tilting (i.e., rotating up and down) and/or panning (i.e., rotating left and right) such that a subject of interest is positioned in a field of view of the camera.

### SUMMARY

A camera is disclosed. The camera includes an image sensor and a f-theta lens fixed relative to the image sensor. The f-theta lens is configured to direct object light from a scene onto the image sensor. An optical axis of the f-theta lens is offset from an optical center of the image sensor such that the image sensor is configured to capture a field of view having an angular bias relative to the optical axis of the f-theta lens.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example camera.

FIG. 2 schematically shows an example camera controller.

FIG. 3 schematically shows an example camera having consistent angular resolution across a horizontal field of view.

FIG. 4 shows an example field angle map of a field of view of an example camera.

FIG. 5 shows an example mapping of a pixel location in a raw image captured by a camera including an image sensor and an f-theta lens having an optical axis that is offset from an optical center of the image sensor to a pixel location in a distortion corrected image based on a distortion correction projection.

FIGS. 6 and 7 schematically show an example multi-camera system.

FIG. 8 is a flow chart of an example method for controlling a camera.

FIG. 9 schematically shows an example computing system.

### DETAILED DESCRIPTION

In conventional cameras, angular resolution may vary among different pixels of an image sensor of the camera. As used herein, the term “angular resolution” of a pixel is defined in terms of an angle subtended by an object in an imaged scene from the perspective of the pixel. For example, a number of pixels that are used to image a face of a human subject in an imaged scene may vary based on a field angle and a depth of the human subject in the scene. As one example, different pixels of an image sensor may have different angular resolutions due to lens distortion characteristics of the particular type of lens employed in the camera. In cameras where the lens is rigidly attached to the image sensor such that an optical axis of the lens is aligned with an optical center of the image sensor, the origin of the radial distortion curve, or image height versus field angle (IH vs FA), defined by lens type, is co-located with the active, or optical, center of the image sensor, such that a horizontal plane aligned with the optical axis of the lens contains a mapping of position across the sensor to field angle across the object scene, which follows the IH vs FA relationship from center to either of the horizontal edges. For a lens type have a linear relationship between image height and field angle (i.e., f-theta lens type), a horizontal plane of consistent angular resolution is aligned with the optical axis of the lens, and pixels of the image sensor that are aligned with this plane represent neighboring projected pixel arcs having substantially constant angular subtend in the object scene, and thus image the same angular resolution.

Furthermore, conventional cameras typically employ a low TV distortion (or f tan(θ)) lens having an optical plane of consistent spatial resolution across an object placed orthogonal to the optical axis of the lens. Rectilinear distortion characteristics of such a lens are beneficial for many types of commonly imaged scenes (e.g., interior rooms, planar objects like pages signs or posters, exterior landscapes), and scenes where straight-line objects appear straight in an image, (or there is a line having consistent spatial resolution across an imaged planar object which is orthogonal to optical axis), among other reasons. However, for moderate to high field of view cameras, the rectilinear distortion characteristics of the low TV distortion lens also cause distortion (e.g., stretching) in corners and edges of an image, because the f tan(θ) lens image distortion relation does not have a plane of consistent angular resolution. Since the imaging follows a tangent relationship, based on a projection origin, the effect is apparent when viewing from a vantage point away from a location representing the projection origin, such that the viewing angle may not match the imaged field of view. In order to avoid such distortion and achieve higher image quality, the camera may be tilted (and/or panned) to position a primary subject of interest in a region of a field of view of the camera that is minimally affected by the corner/edge distortion. In scenarios where the camera is tilted, a subject of interest located along the horizon beyond a certain distance is captured with inconsistent angular resolution such that the subject of interest appears distorted. Further, in scenarios where the camera is used to image multiple subjects of interest at different distances, tilting the camera to image a primary subject of interest causes the other subjects of interest (positioned along the horizon) to be captured with inconsistent angular resolution, which causes these other subjects of interest to appear distorted. Also, subjects of interest positioned along the edges of the image may appear distorted.

Accordingly, the present disclosure is directed to a camera that is optimized for radial applications. In particular, the camera is optimized to have a field of view with a horizontal region having a consistent angular resolution for a designated radial distance from the camera in order to image one or more subjects of interest with minimal distortion. Further, the camera is configured such that the field of view has a vertical angular bias that positions the horizontal region of consistent angular resolution to capture an area of interest where subject(s) of interest are most likely to be located within an imaged scene without requiring the camera to be tilted to aim at the area of interest. For example, the camera may be configured to position the horizontal region of consistent angular resolution to align with an area of interest in an imaged scene where subject(s) of interest are likely standing or sitting.

Such optimization may be achieved by using an f-theta lens in the camera to produce consistent angular resolution across the horizontal field of view of the camera for a horizontal region. Further, the camera's image sensor may be fixed to the f-theta lens such that an optical axis of the f-theta lens is offset from an optical center of the image sensor to create a field of view having a vertical angular bias relative to the optical axis of the f-theta lens. The vertical angular biased field of view shifts the horizontal region of consistent angular resolution to suitably image subject(s) of interest without tilting the camera.

By imaging subject(s) of interest with consistent angular resolution, pixel waste may be reduced, optimizing pixel utilization across the horizontal region. Such optimized pixel utilization allows for similar sized objects at similar radial distances from the camera to be imaged within a similar span of pixels across the image sensor. Such captures of the subjects of interest having a consistent ratio of pixels per object width that is independent of field angle for a given radial distance from the camera may allow for artificial intelligence/machine learning models that are used to evaluate the images to have increased performance consistency of recognizing the subject(s) of interest, within a radial distance from the camera. Moreover, by not requiring tilting of the camera to capture subject(s) of interest with low distortion, a number of distortion correction operations that may be applied to the resulting image may be reduced. Additionally, in scenarios where the camera is used in a device having a fixed position (e.g., incorporated into a mounted display, web camera, or video conferencing device), the form factor (e.g., height) of the device may be reduced since that barrel of the camera does not have to be tilted. Also, by using the f-theta lens in the camera, the resolution of pixels may be radially consistent across the image sensor, such that subject(s) of interest may be imaged with sufficiently high resolution regardless of the position of the subject(s) of interest in the field of view of the camera. Furthermore, in multi-camera applications, such low distortion images of subject(s) of interest may allow for a reduction in processing operations when stitching multiple images from different cameras together, such as for 360-degree imaging.

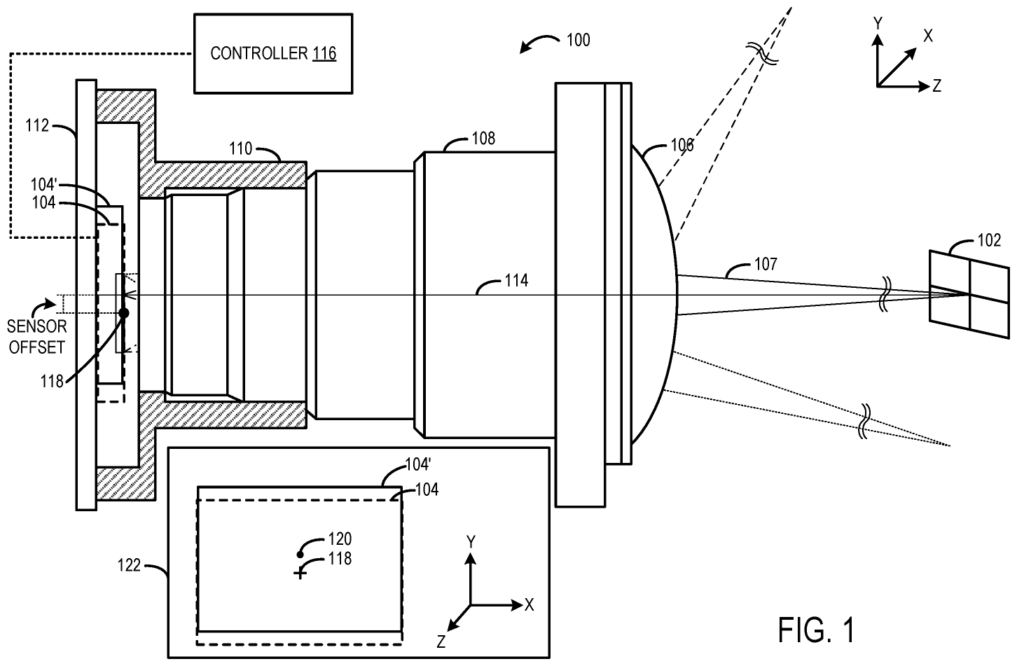

FIG. 1 schematically shows an example camera 100 in simplified form. The camera 100 may be incorporated into any suitable electronic device, such as a single camera device, a multi-camera device (e.g., a 360-degree multi-camera system), a mobile phone, a head-mounted virtual reality or augmented reality device, a tablet, a laptop, a remote-controlled drone, a video conferencing device, or another type of electronic device.

The camera 100 is configured to image a scene 102. The camera 100 includes an image sensor 104 and a f-theta lens 106 positioned to direct object light 107 from the scene 102 onto the image sensor 104. In some implementations, the f-theta lens 106 may be incorporated into an optical system of two or more lenses or other optical elements. The f-theta lens 106, having lens elements held in a lens barrel 108, may be maintained in a fixed position relative to the image sensor 104 via a holder mount structure 110. The holder mount structure 110 may include any suitable material. In one example, the holder mount structure 110 includes metal, such as aluminum. In another example, the holder mount structure 110 includes a polymer, such as a glass-filled polymer. The f-theta lens 106 may be operatively coupled to the holder mount structure 110 in any suitable manner. In one example, the lens barrel 108 and the holder mount structure 110 each may be threaded, such that the f-theta lens 106 is screwed into the holder mount structure 110. In another example, the lens barrel 108 may be cylindrical without threads and bonded to the holder mount structure 110 via an adhesive, such as a rod-shaped barrel placed in a tubular mount with a gap for adhesive.

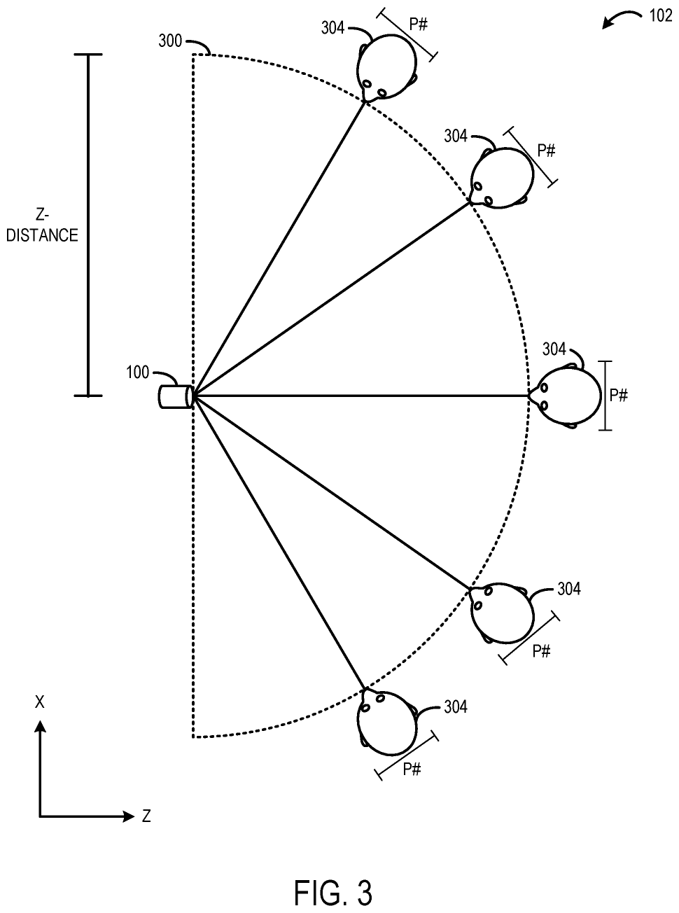

The f-theta lens 106 may be employed in the camera 100 to provide consistent angular resolution across the full horizontal field of view of the image sensor 104. FIG. 3 schematically shows an example camera, such as the camera 100, having consistent angular resolution across a horizontal field of view of the camera 100. Due to the optical characteristics of the f-theta lens 106 in the camera 100, each pixel in a horizontal plane of the image sensor 104 may have a same angular resolution across an arc 300 having a designated radial distance (Z-DISTANCE) in the scene 102. In other words, a subject of interest 304 may be positioned anywhere in the scene 102 along the arc 300 and the subject of interest 304 would be imaged using a same number of pixels (P #) of the image sensor 104 of the camera 100. Such consistent angular resolution may be applied to any suitable arc having any suitable radial distance from the camera 100 in the scene 102 within a designated horizontal region of the field of view of the camera. Such consistent angular resolution allows for subject(s) of interest to be imaged with less pixel subtend variation thus minimal variation of distortion due to pose angle of that subject of interest relative to the position of the camera 100, for example.

In contrast, a camera that employs an f tan(θ) lens may image a human subject with angular resolution that varies across the field of view of the camera. For example, such a camera may use a greater number of pixels when the human subject is located at higher field angles (e.g., edge, corner) of the field of view of the camera along a designated arc in the scene. Further, such a camera may image the human subject with a lesser number of pixels when the human subject is located proximate to the center of the field of view of the camera along the designated arc in the scene. In other words, the camera with the f tan(θ) lens does not have consistent angular resolution across the horizontal field of view of the camera, and thus along the horizontal region the camera 100 with the f-theta lens 106 may image an arc of human subjects with less pixel subtend variation than the camera with an f tan(θ) lens.

Returning to FIG. 1, in the illustrated nonlimiting example camera 100, the lens barrel 108 is operatively coupled to the holder mount structure 110. The holder mount structure 110 is mounted to a printed circuit board (PCB) 112. In one example, the holder mount structure 110 is bonded to the PCB 112 via an adhesive. The image sensor 104 is mounted on the PCB 112 such that an optical axis 114 of the f-theta lens 106 has a fixed offset relative to an optical center 118 of the image sensor 104. In particular, the optical axis of 114 is vertically shifted from the optical center 118 of the image sensor 104.

The lens barrel 108, the holder mount structure 110, and the PCB 112 collectively maintain the f-theta lens 106 in optical alignment with the image sensor 104 (e.g., for the case of using a threaded lens barrel 108 and holder mount structure 110, the holder mount structure 110 may be bonded in position relative to PCB 112 to fix x, y, z position and tip/tilt angle while threads may be substantially used to set the focus). Alternatively, as may be the case for using active alignment (AA), pre-focus position may be set by optically, or mechanically, fixing focus position between lens barrel 108 and holder mount structure 110. Once fixed in this manner, the lens and holder assembly may be actively adjusted in all degrees of freedom and bonded with a gap bond between holder mount structure 110 and PCB 112 to fix x, y, final z focus, tip, tilt and azimuth rotation.

In some examples, the holder mount structure 110 is a rigid holder structure that fixes the lens barrel 108, and thus all elements in the f-theta lens 106 relative to the image sensor 104 along every axis in six degrees of freedom (e.g., x, y, z, tip, tilt, azimuth rotation). For example, a fixed-focus camera may have such an arrangement. In some examples, the holder mount structure 110 may allow movement of the lens barrel 108 relative to the image sensor 104 along at least one axis (e.g., for image stabilization and/or focus, such as by placing an auto-focus voice-coil actuator between lens barrel 108 and holder mount structure 110). In such examples, an offset between the optical axis 114 of the f-theta lens 106 and the optical center 118 of the image sensor 104 is still fixed even though the position of the f-theta lens 106 may move along the Z-axis relative to the position of the image sensor 104.

As discussed above, the optical axis 114 of the f-theta lens 106 has a fixed offset relative to the optical center 118 of the image sensor 104. In the illustrated example, the image sensor 104 is shown having a position that is shifted relative to a position of a hypothetical image sensor 104′ that is optically aligned with the f-theta lens 106. As shown in the sidebar 122, the optical axis of the f-theta lens 106 would align with an optical center 120 of the hypothetical image sensor 104′. However, the actual image sensor 104 is vertically shifted downward (i.e., along the Y axis) relative to the f-theta lens 106, such that the actual optical center 118 of the image sensor 104 is vertically offset from the optical axis 114 of the f-theta lens 106. The offset between the optical center 120 of the hypothetical image sensor 104′ (and correspondingly the optical axis 114 of the f-theta lens 106) and the actual optical center 118 of the image sensor 104 vertically angularly biases a field of view captured by the image sensor 104 relative to a field of view of the hypothetical image sensor. In other words, a field of view of the image sensor 104′ is vertically symmetrical relative to the optical center 120, and the field of view of the image sensor 104 is vertically biased relative to the optical center 118. The lens forms a real, inverted image at the image sensor imaging plane, within an image circle determined by the lens f-theta design. Due to imaging properties of the lens, a pixel position along the vertical dimension of the imaging plane maps to an angular pointing of a field angle along the vertical axis in the object scene. For a camera having lens optical axis pointed in the horizontal plane, hypothetical image sensor 104′ captures an image from a central portion of lens image circle, containing equal portions of the vertical field of view both upward and downward from the horizontal plane. The imaged content is symmetrical about the optical axis, and thus there is no angular bias between the pointing angle represented by the center of the image and the optical axis of lens. However, since the image sensor 104 is shifted downward, the lens forms a real, inverted image at image sensor imaging plane, such that the image sensor captures a vertically offset, lower portion of the image circle of the lens, thus the lower edge of sensing area images high field angles in object scene while the upper edge of the sensing area images low field angles in the object scene. The offset configuration provides an angular bias between the pointing angle represented by the center of the image and the optical axis of the lens, an upward bias angle in this case as shown in FIG. 1. Note that the x,y inverted image is accounted and corrected by the image sensor readout order, such that the image appears as would be seen by a viewer of the object scene. Such vertical angular bias optimizes the field of the view of the camera to capture subject(s) of interest with consistent angular resolution along a horizontal region of the field of view as will be discussed in further detail below.

Note that in the illustrated example, the f-theta lens 106 is configured to accept object light from a region (e.g., an image circle) of the scene 102, and the image sensor 104 is sized to image a sub-region that is smaller than the region of the scene 102. In other words, the acceptance area of the f-theta lens 106 is greater than a sensing area (e.g., area of pixels) of the image sensor 104. This size relationship allows for the image sensor 104 to be shifted relative to the f-theta lens 106 without the field of view of the image sensor being restricted. In other implementations, the image sensor 104 may be sized to image a region that is larger than an acceptance area of the f-theta lens 106 (i.e., the acceptance area of the f-theta lens 106 is smaller than a sensing area (e.g., area of pixels) of the image sensor 104.

Further, note that in the illustrated example, the optical center 118 of the image sensor 104 is horizontally aligned with the optical axis 114 of the f-theta lens. In other examples, the optical center of the image sensor may be horizontally offset from the optical axis of the f-theta lens alternatively or in addition to being vertically offset in order to shift the bias of the field of view of the image sensor 104 horizontally.

The optical center 118 of the image sensor 104 may be vertically offset relative to the optical axis 114 of the f-theta lens 106 by any suitable distance to vertically angularly bias the field of view of the image sensor 104. In some examples, the offset distance is at least fifteen percent of a height of the image sensor 104. In a more particular example, the offset distance is approximately twenty to twenty-five percent of a height of the image sensor 104. For example, if the height of the image sensor is approximately four millimeters, then the offset distance may be approximately one millimeter. Other offset distances may be contemplated herein.

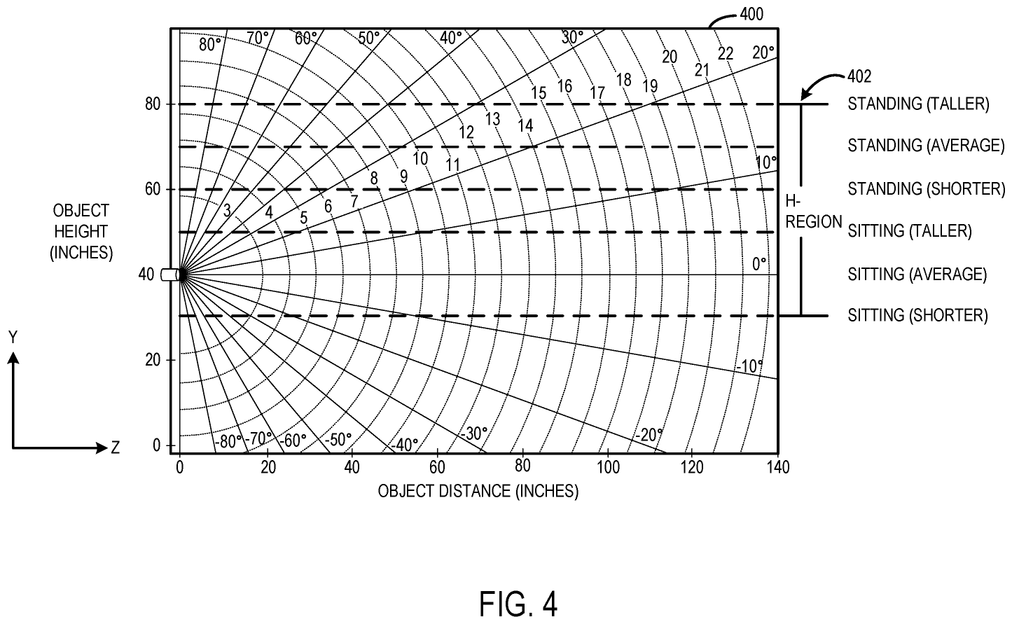

As discussed above, the offset between the image sensor 104 and the f-theta lens 106 vertically biases the field of view of the image sensor 104 to vertically shift a position of a horizontal region of consistent angular resolution. In particular, the horizontal region of consistent angular resolution is positioned to capture an area of interest in the scene 102 where subject(s) of interest are most likely to be located without requiring the camera 100 to be tilted to aim at the area of interest. FIG. 4 shows an example field angle map 400 of an example scene imaged by a camera, such as the camera 100. The perspective of the field angle map 400 is a side view of the camera 100 and the scene. The solid lines extending radially from the camera 100 represent field angles. For example, the 80-degree field angle extends above the camera 100 and the negative 80-degree field angle extends below the camera. The dotted arc lines represent different radial distances from the camera. The number associated with each arc line represents an example designated angular pixel density or ratio of pixels per degree to image a face of human subject (e.g., 54 pixels across a face). Note that other angular pixel density requirements may be used in other examples. In another example, a designated angular pixel density requirement for imaging a human face is 35 pixels across a face. The angular pixel density requirement may be application dependent. For example, the angular pixel density requirement may be based on using captures for facial recognition, facial detection, or another form of machine vision. The distance is listed along the x-axis and the height is listed along the y-axis of the field map 400.

The camera 100 has a field of view with a horizontal region (H-REGION) 402 having a consistent angular resolution for a designated radial distance (each dotted arc line) from the camera 100 in order to image one or more subjects of interest with minimal distortion. The horizontal region 402 is sized and positioned in the field of view to capture human subject(s) of various sizes in various positions. For example, the horizontal region 402 may capture human subject(s) that are shorter height in a sitting position, average height in a sitting position, taller height in a sitting position, shorter height in a standing position, average height in a standing position, and taller height in a standing position. The horizontal region 402 is positioned to allow for a subject of interest located (either sitting or standing) at a relatively far distance (e.g., 11 feet) from the camera 100 to be imaged with a suitable pixel resolution (e.g., 22 pixels per degree angular pixel density required to image 54 pixels across the human subject's face). If the human subject were to move closer to the camera 100 within the horizontal region 402, the pixel resolution of the human subject's face would only increase. In this way, the camera 100 is configured to have good depth performance, or acceptable performance over near to far range of distance, for capturing human subject(s) with acceptable pixel resolution for machine vision, as well as can be considered for viewer consumable image content.

The horizontal region 402 may have any suitable size to capture an object with consistent angular resolution and minimal distortion. In some examples, the horizontal region 402 may cover at least +/−20 degrees of elevation angle from the optical center of the image sensor. In some examples, the horizontal region 402 of the field of view may include at least forty percent of a vertical dimension of the field of view. Other suitable horizontal region dimensions may be contemplated herein.

The field of view has a vertical angular bias that positions the horizontal region 402 of consistent angular resolution to capture an area of interest where subject(s) of interest are most likely to be located within a scene without requiring the camera to be tilted to aim at the area of interest. For example, the image sensor and the f-theta lens are oriented such that the optical axis is substantially parallel to the horizon. Such flat/level physical positioning of the camera 100 within a device may reduce a height form factor of the device relative to a device with a tilted camera configuration, among other industrial design benefits.

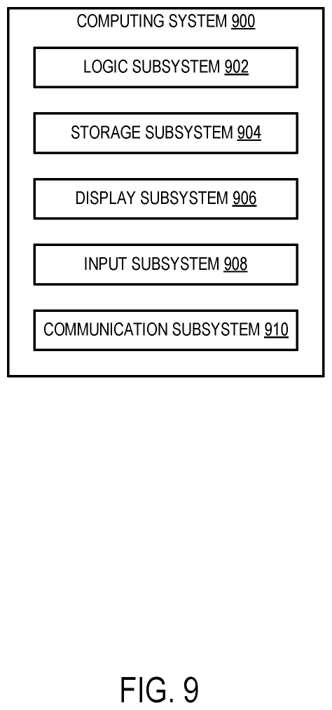

Returning to FIG. 1, the camera 100 further comprises a controller 116 configured to control the image sensor 104 to acquire images of the scene 102 as well as to perform other control operations of the camera 100 as discussed herein. The controller 116 may include a logic subsystem and a storage subsystem. The logic subsystem includes one or more physical devices configured to execute instructions held by the storage subsystem to enact any operation, algorithm, computation, or transformation disclosed herein. In some implementations, the logic subsystem may take the form of an application-specific integrated circuit (ASIC) or system-on-a-chip (SoC), in which some or all of the instructions are hardware- or firmware-encoded. The logic subsystem and the storage subsystem of the controller 116 are discussed in further detail with reference to FIG. 9.

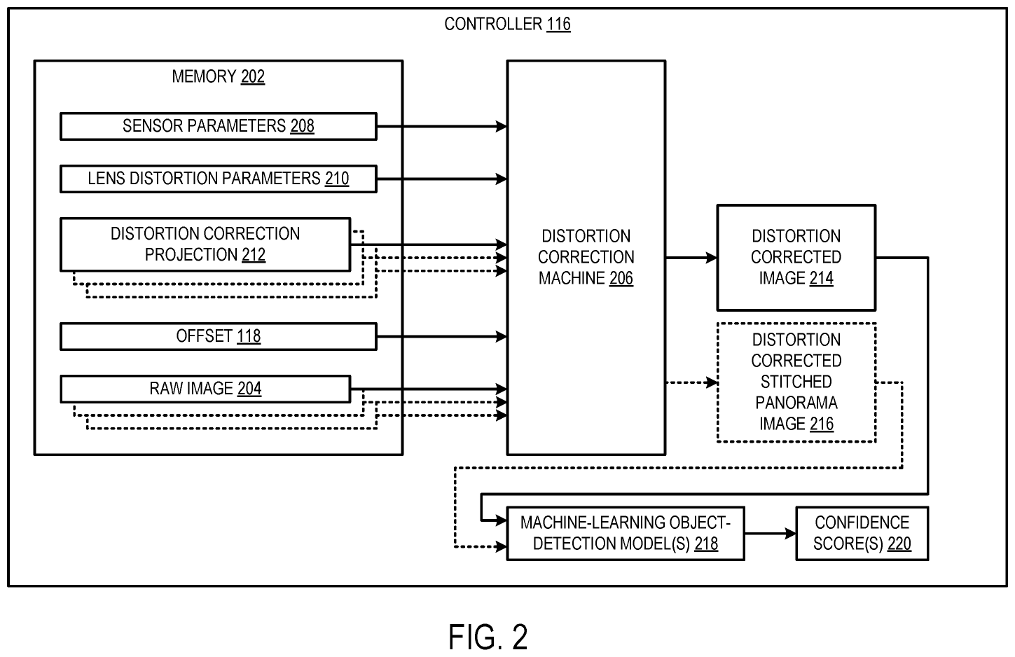

As used herein, the term “raw image” means an image that is generated without any distortion correction and may include monochrome images, color images, and images that have been at least partially processed (e.g., applying a Bayer filter). The camera 100 may be configured to correct image distortion for image presentation, stitching together multiple images of a physical scene to form a panorama image, and for input to a machine-learning model, among other applications. As shown in FIG. 2, the controller 116 is configured to acquire a raw image 204 of a scene via the image sensor 104. The controller 116 may be configured to load the raw image 204 in memory 202 of the camera 100. The controller 116 may include a distortion correction machine 206 configured to translate pixel locations of pixels of the raw image 204 according to a distortion correction projection 212 to generate the distortion corrected image 214.

The distortion correction projection 212 may define a relationship between the pixel locations of the raw image 204 and the translated pixel locations of the distortion corrected image 214 as an inverse function in which the sensor coordinates are mapped to projection plane and/or surface coordinates of the distortion correction projection 212. The distortion correction projection 212 may take any suitable form. For example, the distortion correction projection 212 may include a cylindrical projection, a spherical projection, or a combination of two or more different distortion correction projections. Further, other orientations of lens pointing, and projection may be used. For example, 360° horizontal sweep imaging of a scene may be used with either or a combination of spherical projection and cylindrical projection.

In some implementations, the distortion correction machine 206 may be configured to select the distortion correction projection 212 from a plurality of different distortion correction projections (e.g., rectilinear, spherical, and cylindrical), such that the distortion corrected image 214 is generated according to the selected distortion correction projection. The distortion correction machine 206 may select a distortion correction projection from the plurality of different distortion correction projections in any suitable manner. In some examples, the distortion correction machine 206 may dynamically select a distortion correction projection from the plurality of different distortion correction projections based on operating conditions of the camera 100. In some examples, the distortion correction machine 206 may be configured to select the distortion correction projection from the plurality of different distortion correction projections based on at least a mode of operation of the camera 100.

In some examples, the distortion correction machine 206 may be configured to select the distortion correction projection from the plurality of different distortion correction projections based on at least user input indicating a selection of the distortion correction projection. For example, the camera 100 optionally may include a display and each of the plurality of different distortion correction projections may be listed and/or previewed in a user interface presented on the display. A user of the camera 100 may select one of the distortion correction projections to be used to generate the distortion corrected image 214. A distortion correction projection may be selected from the plurality of different distortion correction projections based on any suitable type of user input.

The distortion correction machine 206 may be configured to determine the relationship between the pixel locations of the pixels of the raw image and the translated pixel locations of the pixels of the distortion corrected image 214 according to the distortion projection 212 in any suitable manner. The distortion correction machine 206 may be configured to perform distortion correction mapping according to a distortion correction projection 212 that uses image sensor parameters 208 and/or lens distortion parameters 210 as inputs.

In one example, the image sensor parameters 208 may include a resolution of the image sensor 104 (e.g., a number of pixels included in the image sensor in both x and y dimensions) and a pixel size of pixels of the image sensor 104 (e.g., size of pixel in both x and y dimensions). In other examples, other image sensor parameters may be considered for the distortion correction projection 212.

In some examples, the distortion correction machine 206 may be configured to use a lookup table that maps the pixel locations of pixels of the raw image to translated pixel locations of pixels of the distortion corrected image according to the distortion correction projection 212 based on the image sensor parameters 208 and the lens distortion parameters 210. In some examples, the distortion correction machine 206 may be configured to use a fit equation, where parameters of the fit equation are derived from the image sensor parameters 208 and the lens distortion parameters 210. In some examples, the distortion correction machine 206 may be configured to estimate the translated pixel locations using a parabolic percentage (p) distortion as a function of the field angle of the raw image 204.

In still other examples, the distortion correction machine 206 optionally may be configured to generate the distortion corrected image 214 further based at least on an image sensor rotation parameter. The image sensor rotation parameter may be considered for pixel mapping in a scenario where the distortion corrected image 214 is included in a plurality of images that are stitched together (e.g., panoramic or 3D image).

The sensor parameters 208 and the lens distortion parameters 210 may be known a priori for the particular type of camera configuration that uses the f-theta lens 106 and the image sensor 104. In some implementations, the sensor parameters 208 and lens distortion parameters 210 may be stored in memory 202, and in some implementations the sensor parameters 208 and lens distortion parameters may be hard coded into distortion correction algorithm(s) of the distortion correction machine 206.

Note that the pixel locations of different pixels in the raw image may be translated and/or interpolated, as by a mesh grid indicating mapping of each integer (x, y) pixel of a distortion corrected image to a floating-point position within the original input image (x′, y′), on an individual pixel basis based on the distortion correction projection. As such, in different instances, pixel locations of different pixels may be translated differently (e.g., different direction and/or distance of translation for different pixels), pixel locations of different pixels may be translated the same (e.g., same direction and/or distance of translation for different pixels), and/or pixel locations of some pixels may remain the same between the raw image 204 and the distortion corrected image 214. Furthermore, distortion correction may include stretching and/or compressing portions of an image.

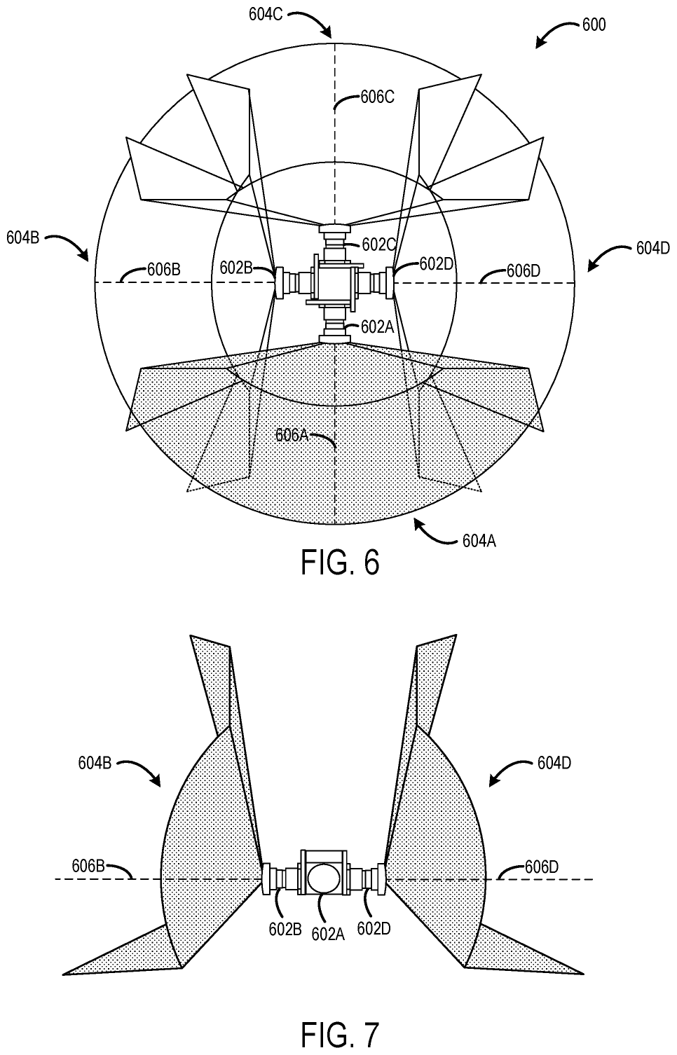

In some implementations, the controller 116 may be configured to control multiple cameras, such as in a multi-camera system (e.g., multi-camera system 600 shown in FIGS. 6 and 7). In such implementations, the distortion correction machine 206 may be configured to receive multiple raw images 204 from different cameras. The different raw images may be captured by the different cameras at the same time and may have different fields of view of the scene 102. For example, the different cameras may be fixed relative to one another such that the different fields of view collectively capture a 360-degree view of the scene 102. The distortion correction machine 206 may be configured to perform image processing operations of the plurality of images to stitch the plurality of images together to form a panorama image 216 of the scene. In some examples, the panorama image may be a 360-degree image of the scene 102. The distortion correction machine 206 may be configured to perform any suitable image processing operation to stitch the plurality of images together to form the panorama image. In some examples, the distortion correction machine 206 may be configured to perform multiple phases of processing operations. For example, the distortion correction machine 206 may first perform distortion correction operations on each of the images, and then stitch together the distortion corrected image to generate a distortion corrected stitched panorama image 216.

The controller 116 includes one or more machine-learning object-detection models 218 configured to analyze distortion corrected images 214/216 acquired via the image sensor to detect and/or recognize content in the distortion corrected images 214/216. The machine-learning object-detection model(s) 218 may employ any suitable machine vision technology to detect and/or recognize content in the images. As a nonlimiting example, the machine-learning object-detection model(s) may include one or more previously trained artificial neural networks.

In some examples, the machine-learning object-detection model(s) 218 may be configured to perform lower-level analysis to identify features within an image, such as corners and edges that may dictate which distortion correction projection is selected. In other examples, the machine-learning object-detection model(s) 218 may be configured to perform higher-level analysis to recognize objects in an image, such as different people. In some examples, the machine-learning object-detection model(s) 218 may be previously trained to perform facial recognition to identify subject(s) of interest in an image. The machine-learning object-detection model(s) 218 may be previously trained to output at least one confidence score indicating a confidence that a corresponding object is present in the distortion corrected image(s) 214/216. For example, the machine-learning object-detection model(s) 218 may be trained to output a confidence corresponding to a human subject (e.g., 93% confident a human subject is in an image). In some implementations, the machine-learning object-detection model(s) 218 are previously trained to output a plurality of confidence scores corresponding to different subjects of interest that may be present in the image (e.g., 93% confident Steve is in the image, 3% Phil is in the image). In some implementations, the machine-learning object-detection model(s) 218 may be configured to identify two or more different subjects of interest in the same image and output one or more confidence scores for each such subjects of interest (93% confident Steve is in a first portion of an image; 88% confident Phil is in second portion of the image).

The controller 116 may be configured to output the distortion corrected image(s) 214/216 in any suitable form. In some examples, the controller 116 may output the distortion corrected image(s) 214/216 as data structures defining a matrix of pixels, each pixel including a value (e.g., color/brightness/depth). The controller 116 may be configured to output the distortion corrected image(s) 214/216 to any suitable recipient internal or external to the camera 100. In one example, the controller 116 may be configured to output the distortion corrected image(s) 214/216 to another processing component for additional image processing (e.g., filtering, computer vision, image compression). In some examples, the processing component may be incorporated into the camera 100. In some examples, the processing component may be incorporated into a remote computing device in communication with the camera 100. In another example, the controller 116 may be configured to output the distortion corrected image(s) 214/216 to an internal or external display device for visual presentation.

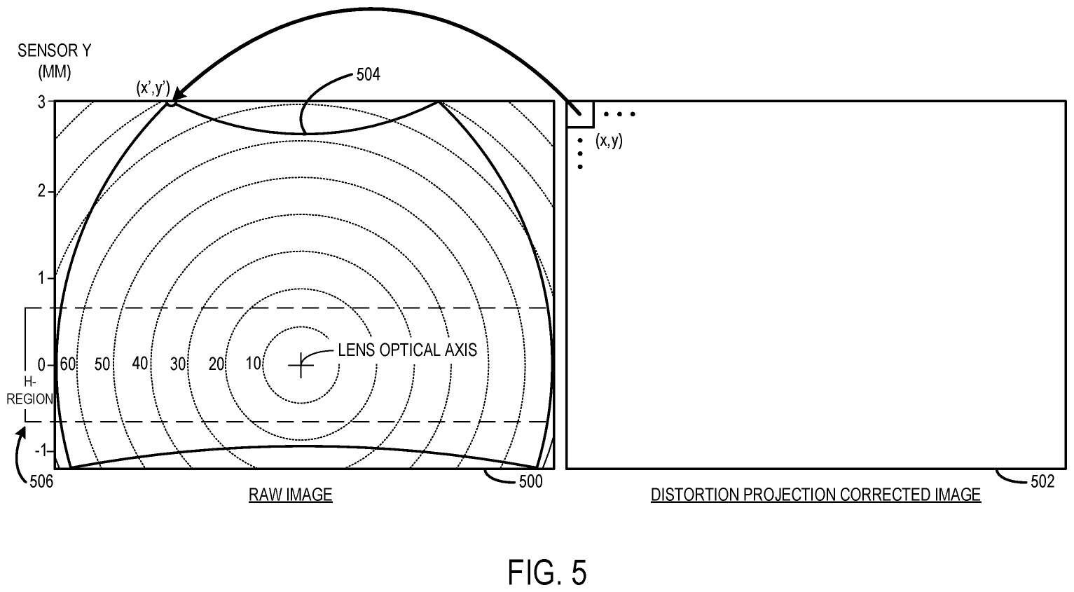

FIG. 5 shows an example raw image 500 and an example distortion corrected image 502. The raw image 500 includes contours in the form of concentric circles that represent the field angle (in degrees) of the f-theta lens. As one example, the f-theta lens may be capable of supporting up to 180 degrees within an image circle at an image plane. In the illustrated example, the contours represent 10-degree increments from 0 degrees to 90 degrees. An outline 504 in the raw image 500 represents frame edges of the distortion corrected image 502 based on the size and position of the image sensor relative to the f-theta lens. In the illustrated example, the raw image 500 is generated by a camera supporting ˜131 degrees of horizontal field of view with the image sensor vertically offset ˜0.95 millimeters relative to the optical axis of the f-theta lens. A horizontal region 506 of consistent angular distortion is positioned approximately within +/−20 degrees of elevation angle from the horizontal plane of the optical axis of the f-theta lens.

The raw image 500 is distortion corrected with a polar projection, such as a spherical or cylindrical projection to produce the distortion projection corrected image 502. The primary difference between the two distortion correction projections is that the height of the cylindrical distortion corrected image would be stretched as compared to a spherical distortion corrected image due to a tangent relationship of the vertical axis. The raw image 500 may be distortion corrected to fit the rectangular frame edges of the distortion projection corrected image 502 such that the distortion projection corrected image 502 is suitable for presentation, such as on a display. Further, in some usage scenarios, such as for machine vision, the corrected image may not be required to be confined to the rectangular frame edges of the distortion corrected image 502, as the image content outside the outline 504 in the raw image 500 may be included in the distortion correction output.

In some implementations, the derived projection mapping equations may be performed as matrix operations in order to facilitate calculation of all pixels within a distortion corrected image in parallel. As one example, a mesh-grid array may be generated for both a two-dimensional (2D) array of x values, X, and a 2D array of y values, Y. The 2D array X may be derived from a one-dimensional (1D) x position grid and the 2D array Y may be derived from a 1D y position grid of the distortion corrected image 802. A matrix calculation of a given projection equation may be applied to the 2D arrays X and Y to determine a 2D array of x′ values, X′ in the raw image 500 and a 2D array of y′ values, Y′ in raw image 500. The values in the 2D arrays X′ and Y′ represent (x′, y′) pixel locations in the raw image 500 that project to (x, y) pixel locations in the distortion corrected image 502 (e.g., integer (x, y) pixel values). In some examples, this operation may include interpolation in order to improve the resolution of the mapping of the distortion corrected image 502 to the raw image 500. In such examples, fractional pixel locations (e.g., floating point (x′, y′) pixel values) may be generated by the operation. Further still, in some examples, the matrix arrays X′ and Y′ may be used to perform a given projection mapping in firmware within a device. In some such examples, such distortion correction projection mappings may be performed at frame rates suitable for video.

FIGS. 6 and 7 schematically show an example multi-camera system 600. FIG. 6 schematically shows an overhead view of the multi-camera system 600. FIG. 7 schematically shows a side view of the multi-camera system 600. The multi-camera system 600 includes a plurality of cameras 602 (e.g., 602A, 602B, 602C, 602D). The plurality of cameras 602 may be representative of the camera 100 shown in FIG. 1. In some implementations, the plurality of cameras 602 of the multi-camera system 600 may be controlled by a shared controller, such as controller 116 shown in FIG. 2.

Each of the plurality of cameras 602 has a fixed position relative to each other camera of the multi-camera system 600. In particular, the optical axes of the f-theta lenses of the plurality of cameras are substantially coplanar. In other words, none of the cameras are tilted which may reduce a height form factor of the multi-camera system 600.

In the illustrated example, the multi-camera system 600 includes four cameras and each camera is radially offset from each neighboring camera by 90 degrees, such that each camera 602 has a field of view 604 (e.g., 604A, 604B, 604C, 604D) that points in a different cardinal direction. Each camera's field of view overlaps with each neighboring camera's field of view. For example, the field of view 604A of the camera 602A overlaps with the field of view 604B of the camera 604B and the field of view 604D of the camera 604D. As shown in FIG. 7, each field of view 604 is vertically biased based on the offset configuration of the image sensor and the f-theta lens in each camera 602. In other words, each field of view 604 is not vertically symmetric relative to an optical axis 606 of a f-theta lens of the camera 602. This vertical bias of the field of view provides a greater overlap between the fields of view of neighboring cameras relative to a configuration where for each camera the optical center of the image sensor is aligned with the optical axis of the lens and cameras are tilted upward to capture the scene. Such increased overlap provides the benefit of requiring a reduced number of processing operations to stitch together images captured by the plurality of camera 602 to generate a stitched panorama image (e.g., a 360-degree image).

The multi-camera system may include any suitable number of cameras arranged in any suitable manner relative to one another in order to collectively provide a field of view for a designated region of a scene. For example, for alternative multi-camera system implementations that use a number of cameras different than four (e.g., 2, 3, 5, 6 or more), the cameras may be arranged relative to one another such that the field of view of one camera overlaps a field of view of at least one other camera of the multi-camera system in order to collectively provide a field of view for a designated region of a scene.

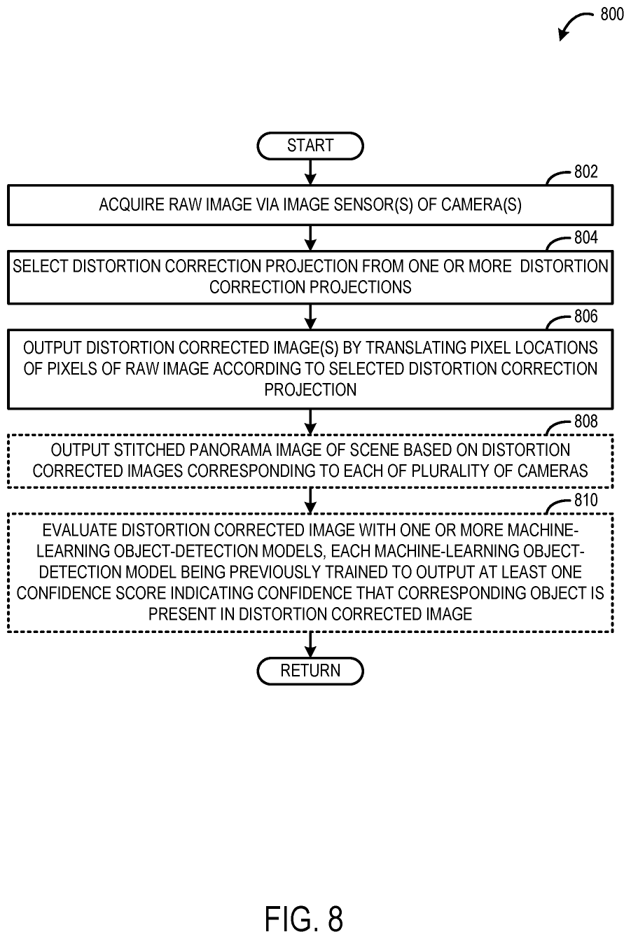

FIG. 8 is a flow chart of an example method 800 for controlling a camera. For example, the method 800 may be performed by the controller 116 of the camera 100 shown in FIG. 1. In some examples, the controller 116 may be configured to control a multi-camera system including a plurality of cameras, such as the multi-camera system 600 shown in FIGS. 6 and 7. At 802, one or more raw images of a scene are acquired via image sensor(s) of one or more cameras. At 804, a distortion correction projection is selected from one or more distortion correction projections. In some implementations, the distortion correction projection may be selected from a plurality of different distortion correction projections (e.g., spherical, cylindrical, 360-degree spherical, 360-degree cylindrical). At 806, one or more distortion corrected images is output by translating pixel location of pixels of the raw image(s) according to the selected distortion correction projection. In some implementations where a plurality of raw images are acquired from a plurality of cameras of a multi-camera system, at 808, optionally a stitched panorama image of the scene may be output by stitching together the plurality of distortion corrected images corresponding to the plurality of different cameras. In some examples, the stitched panorama image may be a 360-degree image of the scene. In some implementations, at 810, optionally the distortion corrected image(s) may be evaluated by one or more machine-learning object-detection models. Each machine-learning object-detection model may be previously trained to output at least one confidence score indicating a confidence that a corresponding object is present in the distortion corrected image. In some implementations, the machine-learning object-detection model(s) may be previously trained to perform facial recognition of one or more human subjects in the scene.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 9 schematically shows a simplified representation of a computing system 900 configured to provide any to all of the compute functionality described herein. Computing system 900 may take the form of one or more cameras, personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices. For example, the computing system 900 may take the form of the camera 100 shown in FIG. 1 or any of the cameras 602 of the multi-camera system 600 shown in FIGS. 6 and 7.

Computing system 900 includes a logic subsystem 902 and a storage subsystem 904. Computing system 900 may optionally include a display subsystem 906, input subsystem 908, communication subsystem 910, and/or other subsystems not shown in FIG. 9.

Logic subsystem 902 includes one or more physical devices configured to execute instructions. For example, the logic subsystem 902 may be configured to execute instructions that are part of one or more applications, services, or other logical constructs. The logic subsystem 902 may include one or more hardware processors configured to execute software instructions. Additionally or alternatively, the logic subsystem 902 may include one or more hardware or firmware devices configured to execute hardware or firmware instructions. Processors of the logic subsystem 902 may be single-core or multi-core, and the instructions executed thereon may be configured for sequential, parallel, and/or distributed processing. Individual components of the logic subsystem 902 optionally may be distributed among two or more separate devices, which may be remotely located and/or configured for coordinated processing. Aspects of the logic subsystem 902 may be virtualized and executed by remotely accessible, networked computing devices configured in a cloud-computing configuration.

Storage subsystem 904 includes one or more physical devices configured to temporarily and/or permanently hold computer information such as data and instructions executable by the logic subsystem 902. When the storage subsystem 904 includes two or more devices, the devices may be collocated and/or remotely located. Storage subsystem 904 may include volatile, nonvolatile, dynamic, static, read/write, read-only, random-access, sequential-access, location-addressable, file-addressable, and/or content-addressable devices. Storage subsystem 904 may include removable and/or built-in devices. When the logic subsystem 902 executes instructions, the state of storage subsystem 904 may be transformed—e.g., to hold different data.

Aspects of logic subsystem 902 and storage subsystem 904 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example. For example, the logic subsystem and the storage subsystem may be included in the controller 116 shown in FIGS. 1 and 2.

The logic subsystem 902 and the storage subsystem 904 may cooperate to instantiate one or more logic machines. The distortion correction machine 206 and the machine-learning object-detection model(s) 218 shown in FIG. 2 are examples of such logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

Machines may be implemented using any suitable combination of state-of-the-art and/or future machine learning (ML), artificial intelligence (AI), and/or natural language processing (NLP) techniques. Non-limiting examples of techniques that may be incorporated in an implementation of one or more machines include support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AI knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods and processes described herein may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters for a particular method or process may be adjusted through any suitable training procedure, in order to continually improve functioning of the method or process.

Non-limiting examples of training procedures for adjusting trainable parameters include supervised training (e.g., using gradient descent or any other suitable optimization method), zero-shot, few-shot, unsupervised learning methods (e.g., classification based on classes derived from unsupervised clustering methods), reinforcement learning (e.g., deep Q learning based on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein may be trained simultaneously with regard to an objective function measuring performance of collective functioning of the plurality of components (e.g., with regard to reinforcement feedback and/or with regard to labelled training data). Simultaneously training the plurality of methods, processes, and/or components may improve such collective functioning. In some examples, one or more methods, processes, and/or components may be trained independently of other components (e.g., offline training on historical data).

When included, display subsystem 906 may be used to present a visual representation of data held by storage subsystem 904. This visual representation may take the form of a graphical user interface (GUI). Display subsystem 906 may include one or more display devices utilizing virtually any type of technology. In some implementations, display subsystem 906 may include one or more virtual-, augmented-, or mixed reality displays.

When included, input subsystem 908 may comprise or interface with one or more input devices. An input device may include a sensor device or a user input device. Examples of user input devices include a keyboard, mouse, touch screen, or game controller. In some implementations, the input subsystem 908 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 910 may be configured to communicatively couple computing system 900 with one or more other computing devices. Communication subsystem 910 may include wired and/or wireless communication devices compatible with one or more different communication protocols. The communication subsystem 910 may be configured for communication via personal-, local- and/or wide-area networks.

In an example, a camera comprises an image sensor having an optical center; and an f-theta lens coupled to the image sensor and configured to direct object light from a scene onto the image sensor, wherein an optical axis of the f-theta lens has a fixed offset from the optical center of the image sensor such that the image sensor is configured to capture a field of view having an angular bias relative to the optical axis of the f-theta lens. In this example and/or other examples, the optical axis of the f-theta lens may be vertically offset relative to the optical center of the image sensor by a vertical offset distance suitable to create a horizontal region in the field of view of the image sensor where each pixel in the horizontal region has a same angular resolution across an arc having a designated radial distance in the scene. In this example and/or other examples, the horizontal region in the field of view of the image sensor may cover at least +/−20 degrees of elevation angle from the optical center of the image sensor. In this example and/or other examples, the horizontal region of the field of view may include at least forty percent of a vertical dimension of the field of view. In this example and/or other examples, the vertical offset distance may be at least fifteen percent of a height of the image sensor. In this example and/or other examples, the f-theta lens may be configured to accept object light from a region of the scene, and the image sensor may be sized to image a sub-region that is smaller than the region of the scene. In this example and/or other examples, the image sensor and the f-theta lens may be oriented such that the optical axis is substantially parallel to the horizon. In this example and/or other examples, the camera may further comprise a controller configured to acquire a raw image of the scene via the image sensor, and output a distortion corrected image from the raw image by translating pixel locations of pixels of the raw image according to a distortion correction projection. In this example and/or other examples, the distortion correction projection may include at least one of a cylindrical projection and a spherical projection. In this example and/or other examples, the controller may be configured to evaluate the distortion corrected image with one or more machine-learning object-detection models, each such machine-learning object-detection model being previously trained to output at least one confidence score indicating a confidence that a corresponding object is present in the image.

In another example, a multi-camera system, comprises a plurality of cameras, each camera having a fixed position relative to each other camera, and each camera comprising an image sensor having an optical center, and an f-theta lens coupled to the image sensor and configured to direct object light from a scene onto the image sensor, wherein an optical axis of the f-theta lens has a fixed offset from the optical center of the image sensor such that the image sensor is configured to capture a field of view having an angular bias relative to the optical axis of the f-theta lens. In this example and/or other examples, the multi-camera system may further comprise a controller configured to for each camera of the plurality of cameras, acquire a raw image of the scene via the image sensor of the camera, generate a distortion corrected image from the raw image by translating pixel locations of pixels of the raw image according to a distortion correction projection, and output a stitched panorama image of the scene based on distortion corrected images corresponding to each of the cameras. In this example and/or other examples, the stitched panorama image may be a 360-degree image of the scene. In this example and/or other examples, for each camera of the plurality of cameras, the optical axis of the f-theta lens may be vertically offset relative to the optical center of the image sensor by a vertical offset distance suitable to create a horizontal region in the field of view of the image sensor where each pixel in the horizontal region has a same angular resolution across an arc having a designated radial distance in the scene.

In another example, a camera comprises an image sensor having an optical center, an f-theta lens coupled to the image sensor and configured to direct object light from a scene onto the image sensor, wherein an optical axis of the f-theta lens has a fixed offset from the optical center of the image sensor such that the image sensor is configured to capture a field of view having a vertical angular bias relative to the optical axis of the f-theta lens, and a controller configured to acquire a raw image of the scene via the image sensor, and output a distortion corrected image from the raw image by translating pixel locations of pixels of the raw image according to a distortion correction projection. In this example and/or other examples, the optical axis of the f-theta lens may be vertically offset relative to the optical center of the image sensor by a vertical offset distance suitable to create a horizontal region in the field of view of the image sensor where each pixel in the horizontal region has a same angular resolution across an arc having a designated radial distance in the scene. In this example and/or other examples, the distortion correction projection may include a cylindrical projection. In this example and/or other examples, the distortion correction projection may include a spherical projection. In this example and/or other examples, the controller may be configured to evaluate the distortion corrected image with one or more machine-learning object-detection models, each such machine-learning object-detection model being previously trained to output at least one confidence score indicating a confidence that a corresponding object is present in the distortion corrected image. In this example and/or other examples, the one or more machine-learning object-detection models may be previously trained to output at least one confidence score indicating a confidence that a face is present in the distortion corrected image.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A camera comprising:
an image sensor having an optical center; and
an f-theta lens coupled to the image sensor and configured to accept object light from a region of a scene and direct object light from the region of the scene onto the image sensor, wherein an optical axis of the f-theta lens has a fixed offset from the optical center of the image sensor such that the image sensor is configured to capture a field of view having an angular bias relative to the optical axis of the f-theta lens, wherein the image sensor is sized to image a sub-region that is smaller than the region of the scene.

2. The camera of claim 1, wherein the optical axis of the f-theta lens is vertically offset relative to the optical center of the image sensor by a vertical offset distance suitable to create a horizontal region in the field of view of the image sensor where each pixel in the horizontal region has a same angular resolution across an arc having a designated radial distance in the scene.

3. The camera of claim 2, wherein the horizontal region in the field of view of the image sensor covers at least +20 degrees and −20 degrees of elevation angle from the optical center of the image sensor.

4. The camera of claim 2, wherein the horizontal region of the field of view includes at least forty percent of a vertical dimension of the field of view.

5. The camera of claim 2, wherein the vertical offset distance is at least fifteen percent of a height of the image sensor.

6. (canceled)

7. The camera of claim 1, wherein the image sensor and the f-theta lens are oriented such that the optical axis is substantially parallel to the horizon.

8. The camera of claim 1, further comprising:
a controller configured to:
acquire a raw image of the scene via the image sensor; and
output a distortion corrected image from the raw image by translating pixel locations of pixels of the raw image according to a distortion correction projection.

9. The camera of claim 8, wherein the distortion correction projection includes at least one of a cylindrical projection and a spherical projection.

10. The camera of claim 7, wherein the controller is configured to evaluate the distortion corrected image with one or more machine-learning object-detection models, each such machine-learning object-detection model being previously trained to output at least one confidence score indicating a confidence that a corresponding object is present in the image.

11. A multi-camera system, comprising:
a plurality of cameras, each camera having a fixed position relative to each other camera, and each camera comprising:
an image sensor having an optical center; and
an f-theta lens coupled to the image sensor and configured to direct object light from a scene onto the image sensor, wherein an optical axis of the f-theta lens has a fixed offset from the optical center of the image sensor such that the image sensor is configured to capture a field of view having an angular bias relative to the optical axis of the f-theta lens, wherein each camera is radially offset from each neighboring camera of the plurality of cameras such that each camera's field of view overlaps with each neighboring camera's field of view, and each camera is oriented in the multi-camera system such that the optical axis of the lens is higher than the optical center of the image sensor for each camera.

12. The multi-camera system of claim 11, further comprising:
a controller configured to:
for each camera of the plurality of cameras,
acquire a raw image of the scene via the image sensor of the camera;
generate a distortion corrected image from the raw image by translating pixel locations of pixels of the raw image according to a distortion correction projection; and
output a stitched panorama image of the scene based on distortion corrected images corresponding to each of the cameras.

13. The multi-camera system of claim 12, wherein the stitched panorama image is a 360-degree image of the scene.

14. The multi-camera system of claim 11, wherein, for each camera of the plurality of cameras, the optical axis of the f-theta lens is vertically offset relative to the optical center of the image sensor by a vertical offset distance suitable to create a horizontal region in the field of view of the image sensor where each pixel in the horizontal region has a same angular resolution across an arc having a designated radial distance in the scene.

15. A camera comprising:
an image sensor having an optical center;
an f-theta lens coupled to the image sensor and configured to accept object light from a region of a scene and direct object light from the region of the scene onto the image sensor, wherein an optical axis of the f-theta lens has a fixed offset from the optical center of the image sensor such that the image sensor is configured to capture a field of view having a vertical angular bias relative to the optical axis of the f-theta lens, wherein the image sensor is sized to image a sub-region that is smaller than the region of the scene; and
a controller configured to:
acquire a raw image of the scene via the image sensor; and
output a distortion corrected image from the raw image by translating pixel locations of pixels of the raw image according to a distortion correction projection.

16. The camera of claim 15, wherein the optical axis of the f-theta lens is vertically offset relative to the optical center of the image sensor by a vertical offset distance suitable to create a horizontal region in the field of view of the image sensor where each pixel in the horizontal region has a same angular resolution across an arc having a designated radial distance in the scene.

17. The camera of claim 15, wherein the distortion correction projection includes a cylindrical projection.

18. The camera of claim 15, wherein the distortion correction projection includes a spherical projection.

19. The camera of claim 15, wherein the controller is configured to evaluate the distortion corrected image with one or more machine-learning object-detection models, each such machine-learning object-detection model being previously trained to output at least one confidence score indicating a confidence that a corresponding object is present in the distortion corrected image.

20. The camera of claim 19, wherein the one or more machine-learning object-detection models are previously trained to output at least one confidence score indicating a confidence that a face is present in the distortion corrected image.

21. The multi-camera system of claim 11, wherein the optical axis of each camera's f-theta lens is coplanar with the optical axis of each other camera's f-theta lens.
